(19) United States
(12) Patent Application Publication
(10) Pub. No.: US 2026/0268525 A1
(43) Pub. Date: Sep. 10, 2026

(54) DYNAMIC RECALIBRATION OF STEREOSCOPIC CAMERA SYSTEM

(71) Applicant: Luxonis Holding Corporation, Boulder, CO (US)

(72) Inventors: Matic Tonin, Kamnik (SI); Cenek Albl, Vestec (CZ)

(21) Appl. No.: 19/070,281

(22) Filed: Mar. 4, 2025

(51) Int. Cl. G06T 7/80; G06T 7/73; G06T 15/00; H04N 13/246

(52) U.S. Cl. CPC G06T 7/85; G06T 7/75; G06T 15/005; H04N 13/246; G06T 2200/04; G06T 2207/10012; G06T 2207/10028

(57) ABSTRACT

A facility for calibrating a stereoscopic camera system that captured two 2D images is described. For each of several features depicted in both images, in each of the images, the facility determines a distance between an original position of the feature in the image, and a second position of the feature in the image obtained by (1) applying a computer vision model using a first set of calibration values to forward-project the original position of the feature in both of the images to a projected position in 3D space, then (2) applying the computer vision model using the first set of calibration values to backward-project the projected position back into the images. The facility determines an error measure based upon the determined distances, and applies an optimization mechanism to the first set of calibration values to obtain a second set of calibration values that seeks to reduce the error measure.

### BACKGROUND

Stereoscopic camera systems imitate the binocular mechanism for human vision by arranging a pair of cameras separated by a baseline distance that point in the same general direction to together capture a scene. A computer vision model transforms the two-dimensional images outputted by this camera pair to project a three-dimensional image of the scene.

Calibration of a stereoscopic camera system involves adapting variables in a computer vision model used to process the system's output to attributes of the system including intrinsic attributes of individual camera module—such as focal length, optical axis, and lens distortion—and extrinsic attributes of the entire system—such as the relative orientation and displacement of the two camera modules. Calibration is conventionally performed by training the system on a specialized visual target—such as a checkerboard of known dimensions and grid size—and executing calibration software against the images of the target produced by the system.

### BRIEF DESCRIPTION OF THE DRAWINGS

FIG. 1 is a perspective diagram showing a typical stereoscopic camera system.

FIGS. 2A and 2B are layout diagrams that show angles and measures of the relative positioning of cameras of a stereoscopic camera system.

FIG. 3 is a data flow diagram showing the operation of a computer vision model.

FIG. 4 is a block diagram showing some of the components typically incorporated in at least some of the computer systems and other devices on which the facility operates.

FIG. 5 is a memory diagram showing sample contents of the memory shown in FIG. 4.

FIG. 6 is a flow diagram showing a process performed by the facility in some embodiments to calibrate variables of a computer vision model with respect to a particular stereoscopic camera system.

### DETAILED DESCRIPTION

The inventors have recognized that conventional techniques for calibrating stereoscopic camera systems that use specialized visual targets have meaningful disadvantages that include: (a) the specialized visual target must be available at the time calibration is needed; (b) the user of the system must manually discover the need for calibration, and interrupt their productive use of the system to perform calibration; and (c) the user must manually manage the calibration process, by (1) setting up the specialized visual target, (2) aiming the system at the target, and (3) triggering the execution of a calibration program.

In response to recognizing these disadvantages, the inventors have conceived and reduced to practice a software and/or hardware facility for performing dynamic calibration of a stereoscopic camera system (“the facility”). In particular, the facility calibrates the camera system by determining values of the model optimized for the current state of the system, based on images captured from an arbitrary visual scene by the system.

In some embodiments, the facility extracts features from the captured images; round-trip projects these features, first into a 3D image, then back into the 2D images; and applies optimization techniques against the shift in position of these extracted features through the round-trip projection. Doing so serves to adapt the system to changes to the system that have occurred since the system's initial calibration in the factory, such as thermal effects, mechanical changes, chemical processes, etc.

In various embodiments, a user can invoke calibration explicitly to solve issues observed in the camera's output—such as inaccurate depth-sensing results—and/or the facility periodically invokes calibration preemptively to correct miscalibration before it is observed.

In some embodiments, the facility performs recalibration as described above after an initial calibration of a different type, such as one using a specialized visual target.

By operating in some or all of the ways described above, the facility accomplishes calibration of the system without the need for specialized targets or the capture of a particular scene, enabling this to occur at any time, with no setup steps.

Additionally, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, where the facility initiates calibration automatically, no resources are consumed to receive and process an explicit calibration command from the user. In some cases, specialized hardware and/or software for explicitly launching calibration can be omitted from the camera system, making it a simpler and less failure-prone mechanism.

Further, for at least some of the domains and scenarios discussed herein, the processes described herein as being performed automatically by a computing system cannot practically be performed in the human mind, for reasons that include that the starting data, intermediate state(s), and ending data are too voluminous and/or poorly organized for human access and processing, and/or are a form not perceivable and/or expressible by the human mind; the involved data manipulation operations and/or subprocesses are too complex, and/or too different from typical human mental operations; required response times are too short to be satisfied by human performance; etc. For example, the computations made by the facility to perform projection and optimization in its calibration are too complex and extensive to be practically performed in a human mind.

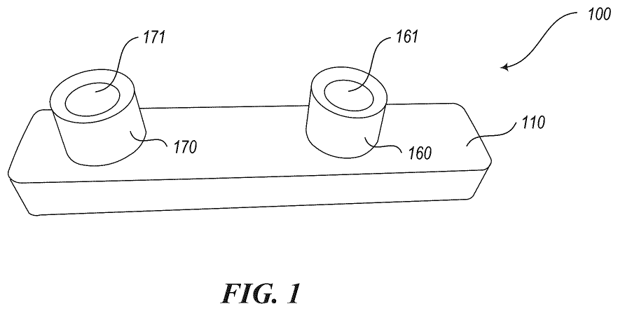

FIG. 1 is a perspective diagram showing a typical stereoscopic camera system. The camera system includes a base 110, containing a first camera 160 having a lens 161, and a second right camera 170 having a lens 171. In use, the camera system is typically positioned in a way that places the scene to be captured in front of the two lenses. While the camera system can be positioned in any of the rotational positions that direct the lenses toward the scene, it is often rotationally positioned so that the lenses are at least roughly horizontal to one another, in a way that emulates the human visual mechanism.

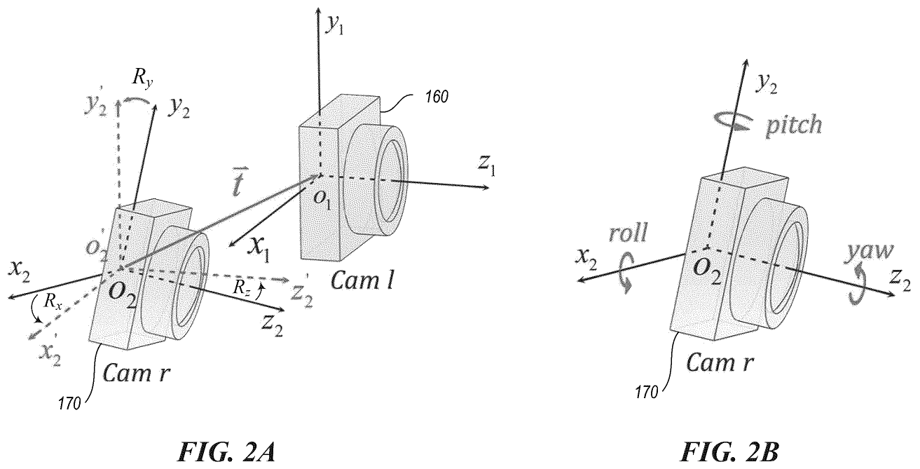

FIGS. 2A and 2B are layout diagrams that show angles and measures of the relative positioning of cameras of a stereoscopic camera system. FIG. 2A shows two cameras, a left camera 160 having an optical center O₁, and a right camera 170 having an optical center O₂. In some embodiments, optical center Of is the point at which the optical axis z₁ intersects a sensing plane of the left camera, and optical center O₂ the point at which the optical axis z₂ intersects a sensing plane of the right camera. It can be seen that each of the cameras defines its own frame of reference: the left camera defines frame of reference x₁, y₁, z₁, centered on optical center O₁, and the right camera the frame of reference x₂, y₂, z₂, centered on optical center O₂. The displacement of the two cameras is characterized by the three-dimensional vector \vec{t} that spans the space between the optical center O₂ of the right camera 170 and the optical center O₁ of the left camera 160. The magnitude of this vector is sometimes referred to as the camera system's baseline distance. The orientation of the right camera relative to the left camera is characterized by, for each of the three axes, the angle from the right camera's version of that axis to the left camera's version of this axis, e.g., R_{z} from optical axis z₂ of the right camera to optical axis z′₂ of the left camera.

FIG. 2B shows names for the rotational dimensions of the right camera relative to the left camera: yaw is rotation about the optical axis z₂, pitch the rotation about the vertical axis y₂, and roll the rotation about the horizontal axis x₂.

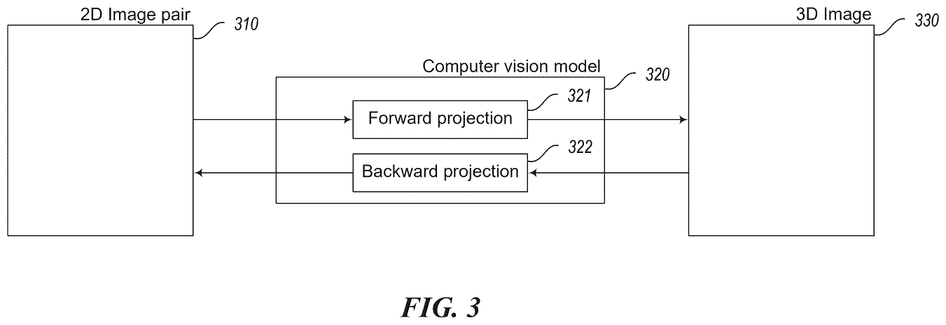

FIG. 3 is a data flow diagram showing the operation of a computer vision model. The computer vision model 320 can perform a forward projection 321 against a pair 310 of 2D images, such as a pair of 2D images contemporaneously captured by the two cameras of a stereoscopic camera system. The forward projection produces a 3D image 330, or a 3D representation of another type of the space captured by the stereoscopic camera system. The computer vision model can also perform backward projection 322 to transform a 3D image into a 2D image pair. With respect to both projections, the computer vision model relies upon a number of calibration variables. These calibration variables can relate to attributes of the camera system including intrinsic attributes of the individual camera modules—such as focal length, optical axis, and lens distortion—as well as extrinsic attributes of the entire camera system—such as the relative orientation and displacement of the two camera modules. These variables are calibrated by the facility.

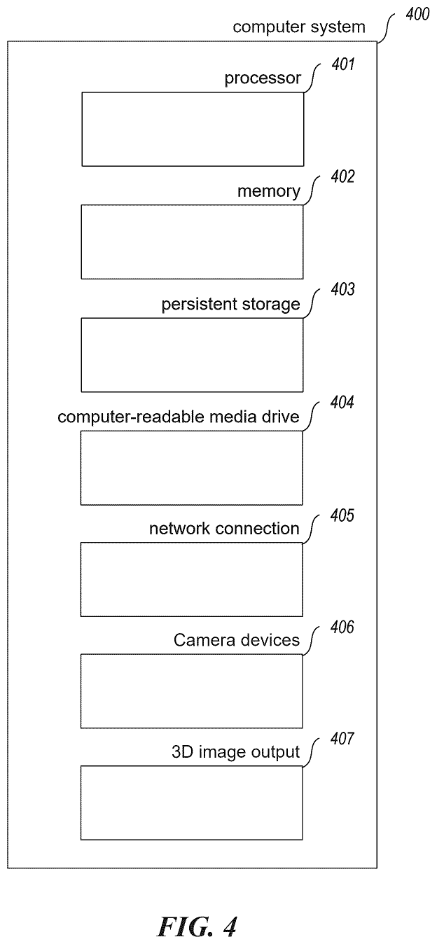

FIG. 4 is a block diagram showing some of the components typically incorporated in at least some of the computer systems and other devices on which the facility operates. In various embodiments, these computer systems and other devices 400 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 401 for executing computer programs and/or training or applying machine learning models, such as a CPU, GPU, TPU, NNP, FPGA, or ASIC; a computer memory 402—such as RAM, SDRAM, ROM, PROM, etc.—for storing programs and data while they are being used, including the facility and associated data, an operating system including a kernel, and device drivers; a persistent storage device 403, such as a hard drive or flash drive for persistently storing programs and data; a computer-readable media drive 404, such as a floppy, CD-ROM, or DVD drive, for reading programs and data stored on a computer-readable medium; a network connection 405 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like; camera devices 406, such as one or more stereoscopic camera systems and/or their individual components; and a 3D image output 407 for outputting 3D images generated by the computer system from two-dimensional images captured by the captured devices, or characteristics of such 3D images. None of the components shown in FIG. 1 and discussed above constitutes a data signal per se. While computer systems configured as described above are typically used to support the operation of the facility, those skilled in the art will appreciate that the facility may be implemented using devices of various types and configurations, and having various components.

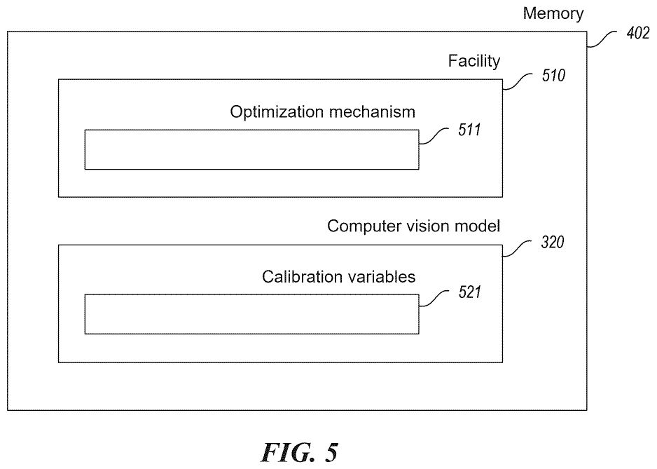

FIG. 5 is a memory diagram showing sample contents of the memory shown in FIG. 4. The memory 402 stores software 510 constituting the facility, including one or more optimization mechanisms 511 for optimizing quantities of computer vision model calibration variables to produce the best or better results. The memory also stores a computer vision model 320, which maintains these calibration variables 521 and uses them in performing three-dimensional projection.

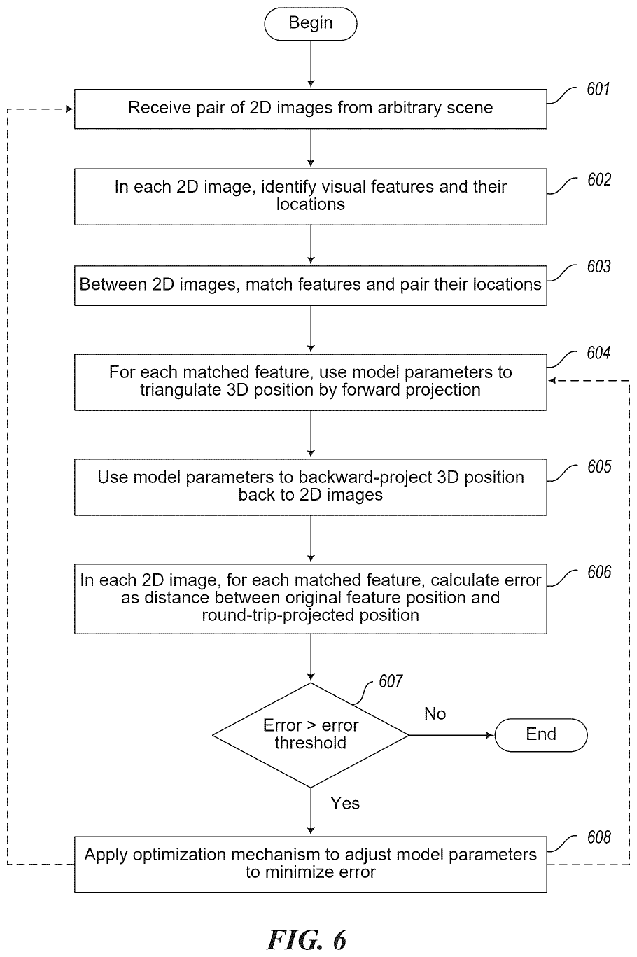

FIG. 6 is a flow diagram showing a process performed by the facility in some embodiments to calibrate variables of a computer vision model with respect to a particular stereoscopic camera system. In various embodiments, the facility performs this process in response to a variety of events, including the expiration of a timer, set for periods such as each second, ten seconds, thirty seconds, a minute, five minutes, ten minutes, thirty minutes, sixty minutes, two hours, four hours, twelve hours, a day, two days, four days, seven days, one month, etc. ; explicit user activation, such as using a physical switch, button, other physical control, visual user interface element, etc., of the camera system; an automatic assessment of one or more produced 3D images that determines them to be of inadequate quality; etc.

In act 601, the facility receives a pair of 2D images captured using the camera system from an arbitrary scene at the same time or nearly the same time. “Arbitrary” means that the scene need not contain a checkerboard or any other specialized visual target, or special contents of any other type. In act 602, in each of the 2D images of the pair received in act 601, the facility identifies visual features and their locations. In various embodiments, the facility uses one or more of a variety of techniques or mechanisms to perform feature identification, including Scale-Invariant Feature Transform, Speeded-Up Robust Features, Oriented FAST and Rotated BRIEF, Harris Corner Detection, Shi-Tomasi Corner Detector, Features from Accelerated Segment Test, Laplacian of Gaussian, Gabor Filters, and/or Binary Robust Invariant Scalable Keypoints.

In act 603, between the 2D images of the pair, the facility matches features, such as features having the same descriptors, and correlated locations in the 2D images. For each feature that the facility matches between the 2D images, it stores a location pair made up of a feature's location in the left 2D image and the feature's location in the right 2D image. In act 604, for each feature matched in act 603, the facility applies for the computer vision model using the present values of its calibration values to perform a forward projection that determines a 3D position for the feature based upon the locations of the feature in the 2D images of the pair. In act 605, the facility applies the computer vision model using the present value of the calibration variables to perform a backward-projection from the 3D position determined for the match feature in act 604 back to the left and right two-dimensional images.

In act 606, the facility determines an error measure for this round trip projection across all of the matched features that is based upon the distances in the 2D images, for each matched feature, between its original location in the 2D image and its round-trip-projected position determined in act 605. In some embodiments, the facility uses a variety of approaches to determining this error measure in act 606, including one or more of mean squared error, root mean squared error, mean absolute error, Huber loss, Cauchy loss, Log-Cosh loss, R squared, binary cross entropy loss, and/or categorical cross-entropy loss. This error measure is sometimes referred to herein as “reprojection error.”

In act 607, if the error measure determined in act 606 exceeds a predetermined maximum error threshold, then the facility continues in act 608, else this process concludes.

In act 608, the facility applies an optimization mechanism to adjust model parameters in a way that minimizes or reduces this error measure. In various embodiments, the facility uses a variety of optimization techniques and mechanisms in act 608, such as non-linear least squares optimization; trust-region techniques, including Gauss Newton, Levenberg-Marquardt, and/or dogleg; and/or line-search methods including steepest descent, conjugate gradient, or Broyden-Fletcher-Goldfarb-Shanno. In some embodiments, the facility performs preconditioning in advance of applying the optimization mechanism(s) to normalize the level of influence each variable or parameter has, and/or the scale of the variable or parameter. In some embodiments, the facility performs this optimization in a way that constrains the opportunity to influence certain variables or parameters that are less likely to have changed since the last calibration. In one such example, the error term to the error measure that penalizes changes to the value of the camera system's baseline distance variable, which has a low likelihood of having changed since the last calibration. In some embodiments, after act 608, the facility continues in act 601 to receive a new pair of 3D images, which may reflect at least some change in camera system position, and/or dynamic changes in the visual contents of the scene. In this case, the facility continues in act 602 to perform another round of assessment, and potentially calibration, based upon this new pair of images. In some embodiments, after act 608, the facility continues in act 604 to perform an additional round of assessment and potentially recalibration based upon the pair of 2D images already received in act 601.

Those skilled in the art will appreciate that the acts shown in FIG. 6 may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

In some embodiments (not shown), the facility determines whether to perform recalibration based upon determining reprojection error in accordance with acts 601-606 in a sliding window—i.e., considering the last n frames captured m seconds apart.

In some embodiments, the facility determines a new set of calibration variable values using an accumulated set of 2D images. The facility uses this new set of calibration variable values to produce 3D images from those accumulated 2D images. The facility compares properties of these obtained 3D images to 3D images produced from the same 2D images using pre-calibration variable values. The facility computes statistics such as fillrate (number of pixels with valid depth) and overall noise level along the z (depth) axis. If the set of 3D images created using the new set of parameters show a greater-than-threshold improvement in these measures, the facility applies the new calibration variable values. In some embodiments, the facility includes a visual user interface that provides feedback to the camera system's user about aiming the camera system for purposes of the recalibration. In some embodiments, the facility displays directions to compose the capture such that visual features are evenly distributed across the 2D images, and/or so that the features are well-distributed across the three-dimensional volume of the scene. In some embodiments, the user interface dynamically displays a signal indicating whether the captured scene provides the needed coverage, or, if it does not, instructions to move the camera slowly to obtain captures that are more likely to satisfy these objectives.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system, comprising:
two cameras;
a structure to which the two cameras are mounted;
at least one processor; and
one or more memories collectively having contents configured to cause the processor to perform a method, the method comprising:
(a) using the two cameras to capture a first stereoscopic pair of 2D images of a first scene, the first pair of 2D images including a left 2D image and a right 2D image;
for each of the 2D images of the first pair:
(b) automatically identifying a plurality of visual features occurring in the 2D image;
(c) for each identified visual feature, determining a location of the visual feature in the 2D image;
(d) matching visual features identified in the left 2D image with visual features identified in the right 2D image;
for each visual feature identified in the left 2D image matched with a visual feature identified in the right 2D image:
(e) applying a computer vision model using a first set of values for a plurality of calibration variables to forward-project locations of the matching visual features in the left and right 2D images of the first pair to obtain a 3D location for the matched features;
(f) applying the computer vision model using the first set of values for the plurality of calibration variables to backward-project the obtained 3D location for the matched features to obtain round-trip-projected locations for the matched features in the left and right 2D images;
(g) determining an error measure attributed to the first set of values for the plurality of calibration variables based upon, for each of at least a portion of the matched features, for both the left and right 2D images of the first pair, the distance between the matched feature's determined and round-trip-projected locations in the 2D image; and
(h) applying an optimization mechanism to adjust the first set of values for the plurality of calibration variables to obtain a second set of values for the plurality of calibration variables, wherein the optimization mechanism seeks in making the adjustment to reduce the determined error measure.

2. The system of claim 1, the method further comprising:
storing the second set of values for the plurality of calibration variables for use in connection in the system.

3. The system of claim 1, the method further comprising:
accessing a second stereoscopic pair of 2D images of a second scene captured by the cameras; and
applying the computer vision model using the second set of values for the plurality of calibration variables to forward-project the left and right 2D images of the second pair to obtain a 3D image of the second scene.

4. The system of claim 1 wherein the method is performed in response to the expiration of a timer.

5. The system of claim 1 wherein the method is performed in response to automatically assessing a level of quality of a 3D image produced by the computer vision model using the first set of values of the plurality of calibration better variables.

6. The system of claim 1 wherein the method is performed in response to receiving an explicit calibration command.

7. The system of claim 1 wherein a distinguished one or more of the plurality of calibration variables relate to a baseline distance separating the optical centers of two cameras,
and wherein the optimization mechanism constrains changes to the distinguished one or more variables.

8. The system of claim 1, the method further comprising:
repeating acts (e), (f), (g), and (h) one or more times with respect to the first pair of 2D images to obtain a resultant set of values for the plurality of calibration variables.

9. The system of claim 1, the method further comprising:
capturing one or more second pairs of 2D images; and
for each of the captured one or more second pairs of 2D images:
repeating acts (a), (b), (c), (d), (e), (f), (g), and (h) one or more times with respect to the captured second pair of 2D images,
to obtain a resultant set of values for the plurality of calibration variables.

10. The system of claim 1, the method further comprising:
determining an aspect in which one or both of the 2D images of the first pair is ill-suited for calibration; and
in response to determining the aspect, outputting a prompt to move the system for the capture of one or more additional pairs of 2D images.

11. The system of claim 10 wherein the determined aspect is that the determined locations of the identified visual features are not fully enough distributed through the area of one or both of the 2D images of the first pair.

12. The system of claim 10 wherein the determined aspect is that physical objects corresponding to the identified visual features are not fully enough distributed through the 3D volume of the scene depicted by the 2D images of the first pair.

13. One or more memories having contents configured to cause a computing system to perform a method, the method comprising:
for each of a plurality of visual features depicted in both of two 2D images captured as a pair by a stereoscopic camera system, in each of the 2D images, determining a distance between an original position of the visual feature in the 2D image, and a second position of the visual feature in the 2D image obtained by (1) applying a computer vision model using a first set of calibration values to forward-project the original position of the visual feature in both of the 2D images to a projected position in 3D space, then (2) applying the computer vision model using the first set of calibration values to backward-project the projected position in 3D space back into the 2D images;
determining a first error measure based upon the determined distances;
applying an optimization mechanism to the first set of calibration values to obtain a second set of calibration values that seeks to reduce the determined first error measure; and
storing the second set of calibration values for use with the stereoscopic camera system.

14. One or more memories storing a data structure, the data structure comprising:
a plurality of entries, each of the entries specifying a calibrated value for a different one of a plurality of calibration variables used by a computer vision model to project a 3D image from a stereoscopic pair of 2D images captured by a particular stereoscopic imaging system, the calibrated values having been produced by performing multiple iterations of optimizing the values of the calibration variables to reduce an error measure reflecting deviation in locations in the 2D images between (1) features originally present in the 2D images, and (2) the same features round-trip projected (a) from the 2D images to a 3D image, then (b) from the 3D image back to the 2D images using preceding values of the plurality of calibration variables, such that the contents of the data structure are usable and applying the computer vision model to a particular stereoscopic pair of images captured by the particular stereoscopic imaging system.

15. A method in a computing system, comprising:
(a) accessing a first stereoscopic pair of 2D images of a first scene captured by a particular stereoscopic camera system, the first pair of 2D images including a left 2D image and a right 2D image;
for each of the 2D images of the first pair:
(b) automatically identifying a plurality of visual features occurring in the 2D image;
(c) for each identified visual feature, determining a location of the visual feature in the 2D image;
(d) matching visual features identified in the left 2D image with visual features identified in the right 2D image;
for each visual feature identified in the left 2D image matched with a visual feature identified in the right 2D image:
(e) applying a computer vision model using a first set of values for a plurality of calibration variables to forward-project locations of the matching visual features in the left and right 2D images of the first pair to obtain a 3D location for the matched features;
(f) applying the computer vision model using the first set of values for the plurality of calibration variables to backward-project the obtained 3D location for the matched features to obtain round-trip-projected locations for the matched features in the left and right 2D images;
(g) determining an error measure attributed to the first set of values for the plurality of calibration variables based upon, for each of at least a portion of the matched features, for both the left and right 2D images of the first pair, the distance between the matched feature's determined and round-trip-projected locations in the 2D image; and
(h) applying an optimization mechanism to adjust the first set of values for the plurality of calibration variables to obtain a second set of values for the plurality of calibration variables, wherein the optimization mechanism seeks in making the adjustment to reduce the determined error measure.

16. The method of claim 15, further comprising:
storing the second set of values for the plurality of calibration variables for use in connection with the particular stereoscopic camera system.

17. The method of claim 15, further comprising:
accessing a second stereoscopic pair of 2D images of a second scene captured by the particular stereoscopic camera system; and
applying the computer vision model using the second set of values for the plurality of calibration variables to forward-project the left and right 2D images of the second pair to obtain a 3D image of the second scene.

18. The method of claim 15, further comprising:
capturing the accessed first pair of 2D images, and wherein the method is performed in response to the expiration of a timer.

19. The method of claim 15, further comprising:
capturing the accessed first pair of 2D images,
and wherein the method is performed in response to automatically assessing a level of quality of a 3D image produced by the computer vision model using the first set of values of the plurality of calibration better variables.

20. The method of claim 15, further comprising:
capturing the accessed first pair of 2D images,
and wherein the method is performed in response to receiving an explicit calibration command.

21. The method of claim 15 wherein a distinguished one or more of the plurality of calibration variables relate to a baseline distance separating the optical centers of two cameras of the stereoscopic camera system,
and wherein the optimization mechanism constrains changes to the distinguished one or more variables.

22. The method of claim 15, further comprising:
repeating the sequence of acts (e), (f), (g), and (h) one or more times with respect to the first pair of 2D images to obtain a resultant set of values for the plurality of calibration variables.

23. The method of claim 15, further comprising:
capturing one or more second pairs of 2D images; and
for each of the captured one or more second pairs of 2D images:
repeating the sequence of acts (a), (b), (c), (d), (e), (f), (g), and (h) one or more times with respect to the captured second pair of 2D images,
to obtain a resultant set of values for the plurality of calibration variables.
